(19) United States
(12) Patent Application Publication
(10) Pub. No.: US 2026/0247122 A1
(43) Pub. Date: Aug. 20, 2026

(54) DEVICE, COMPUTER-IMPLEMENTED METHOD, AND COMMUNICATION SYSTEM

(71) Applicant: NINTENDO CO., LTD., Kyoto-shi (JP)

(72) Inventors: Shumpei YASUDA, Kyoto-shi (JP); Hiroyuki TAKEUCHI, Kyoto-shi (JP); Takafumi AOKI, Kyoto-shi (JP); Yohei KOJIMA, Kyoto-shi (JP)

(21) Appl. No.: 19/532,561

(22) Filed: Feb. 6, 2026

(30) Foreign Application Priority Data
Feb. 19, 2025 (JP) 2025-024805

(51) Int. Cl. H04W 4/80; H04W 76/14; H04W 84/12; H04W 84/18

(52) U.S. Cl. CPC H04W 4/80; H04W 76/14; H04W 84/12; H04W 84/18

(57) ABSTRACT

An exemplary device includes a wireless communication controller and a notification unit. The device is configured to transmit a scannable advertising packet, and execute a first notification process for performing first notification to a user in response to a scan request from another device that received the advertising packet.

### CROSS REFERENCE TO RELATED APPLICATION

This non-provisional application is based on Japanese Patent Application No. 2025-024805 filed with the Japan Patent Office on February 19, 2025, the entire contents of which are hereby incorporated by reference.

### FIELD

The present disclosure relates to a device, one or more media, a computer-implemented method, and a communication system.

### BACKGROUND AND SUMMARY

In a case where a device and another device communicate via Bluetooth®, at least one of the devices may execute a specified process after communication establishment.

For example, in a case where a controller communicates with a main unit, in order to notify that communication between the controller and the main unit is established and that the main unit can be operated by the controller, the controller may activate a vibration device or control a visible device such as an LED (Light Emitting Diode) and the like.

There has been a demand to shorten a time until notification as described above is performed.

### Configuration 1

A device according to the present embodiment comprises a wireless communication controller and a notification unit. The device is configured to transmit a scannable advertising packet, and execute a first notification process for performing first notification to a user in response to a scan request from another device that received the advertising packet.

According to configuration 1, the device executes the first notification process in response to the scan request, and therefore the device can perform first notification to the user without necessitating communication establishment. Thereby, a time until notification is performed can be shortened.

### Configuration 2

In configuration 1, the advertising packet may also be connectable.

According to configuration 2, in addition to transmission of the scan request, a wake-up process or a connection process can be started in accordance with the connectable type, and therefore a processing time can be shortened as a whole.

### Configuration 3

In configuration 2, the device may execute a connection process with the another device to establish communication in response to a connection request from the another device, and execute a second notification process for performing second notification to the user in response to a connection notification from the another device after communication is established.

### Configuration 4

In configuration 3, the device may execute the second notification process regardless of presence or absence of execution of the first notification process. According to configuration 4, respective notification of the first notification process and the second notification process can be surely performed.

### Configuration 5

In configuration 3, the device may omit execution of the second notification process when the first notification process is executed. According to configuration 5, a possibility of user confusion due to a plurality of times of notification can be reduced.

### Configuration 6

In any of configurations 3 to 5, at least a part of a notification operation of the first notification process and at least a part of a notification operation of the second notification process may be the same.

### Configuration 7

In any of configurations 1 to 6, the another device may comprise a plurality of wireless communication controllers. The scan request may be transmitted by a first wireless communication controller of the another device. In the connectable advertising packet, an address of a second wireless communication controller of the another device, which is different from the first wireless communication controller, may be specified as a device capable of accepting a connection request.

### Configuration 8

According to the present embodiment, a processing method for a device comprising a wireless communication controller and a notification unit is provided. In the processing method, a scannable advertising packet is transmitted, and a first notification process for performing first notification to a user is executed in response to a scan request from another device that received the advertising packet.

### Configuration 9

A communication system according to the present embodiment comprises a first device comprising a wireless communication controller and a second device comprising a wireless communication controller and a notification unit. The second device is configured to transmit a scannable advertising packet. The first device is configured to transmit a scan request to the second device when the first device receives the advertising packet from the second device. The second device is configured to execute a first notification process for performing first notification to a user in response to the scan request from the first device.

### Configuration 10

According to the present embodiment, a processing method in a communication system comprising a first device comprising a wireless communication controller and a second device comprising a wireless communication controller and a notification unit is provided.

The communication method is characterized in that the second device transmits a scannable advertising packet, the first device transmits a scan request to the second device when the first device receives the advertising packet from the second device, and the second device executes a first notification process for performing first notification to a user in response to the scan request from the first device.

The foregoing and other objects, features, aspects, and advantages of the present disclosure will become more apparent from the following detailed description of the present disclosure when taken in conjunction with the accompanying drawings.

### BRIEF DESCRIPTION OF THE DRAWINGS

FIG. 1 is an exemplary illustrative non-limiting drawing showing an example configuration of a communication system according to the present embodiment.

FIGS. 2 to 4 are exemplary illustrative non-limiting flowcharts showing processing procedures executed by the communication system according to the present embodiment.

FIG. 5 is an exemplary illustrative non-limiting drawing for explaining a process for discarding a scan request in the communication system according to the present embodiment.

FIG. 6 is an exemplary illustrative non-limiting flowchart showing a processing example shown in FIG. 5.

### DETAILED DESCRIPTION OF NON-LIMITING EXAMPLE EMBODIMENTS

Concerning the present embodiment, detailed description is provided while referring to the drawings. The same reference numerals are attached to the same or corresponding parts in the drawings, and the description thereof is not repeated.

### A. Example Configuration of Communication System

First, an example configuration of communication system 1 according to the present embodiment is described. Communication system 1 includes a plurality of communicable devices. Communication system 1 can be applied to a game system, for example.

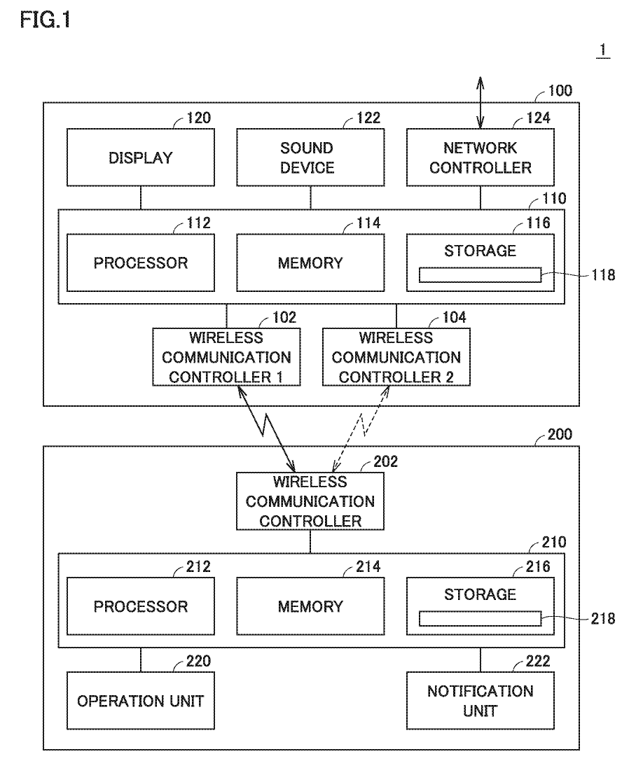

FIG. 1 is a schematic diagram showing an example configuration of communication system 1 according to the present embodiment. Referring to FIG. 1, communication system 1 includes a first device 100 and a second device 200 as examples of devices. Communication system 1 may include a plurality of first devices 100, or may include a plurality of second devices 200.

For example, one first device 100 may perform wireless communication simultaneously with a plurality of second devices 200. One second device 200 may be capable of wirelessly connecting to a plurality of different first devices 100, respectively.

When communication system 1 is applied to a game system, first device 100 may be a main unit device that executes a game application, and second device 200 may be a controller.

First device 100 further includes a first wireless communication controller 102, a second wireless communication controller 104, a control unit 110, a display 120, a sound device 122, and a network controller 124 as an example.

Although FIG. 1 shows an example configuration of first device 100 comprising a plurality of wireless communication controllers, the wireless communication controller included in first device 100 may be one.

Control unit 110 includes, for example, a processor 112, a memory 114, and a storage 116. A storage device or a storage medium such as memory 114 or storage 116 and the like, may be referred to as "memory".

Processor 112 is a processing entity for executing processing provided by first device 100. Processor 112 may be, for example, a CPU (Central Processing Unit) or a GPU (Graphics Processing Unit) and the like. Processor 112 realizes processing described later by loading and executing a system program or an application program stored in storage 116 into memory 114.

Memory 114 is a storage device or a storage medium accessible by processor 112. Memory 114 may be a volatile storage device such as DRAM (Dynamic Random Access Memory) or SRAM (Static Random Access Memory) and the like.

Storage 116 may be a nonvolatile storage medium such as a hard disk or a flash memory and the like. Storage 116 may be a storage medium detachable from first device 100, such as an optical disk or a cartridge and the like. A communication device may be realized by combining first device 100 and the storage medium.

Storage 116 may store pairing information 118. Pairing information 118 includes, for example, an address of one or a plurality of second devices 200 paired with first device 100 and a common key corresponding to each address.

Display 120 displays an image based on a processing result by processor 112 and the like.

Sound device 122 may include at least one of a microphone or a speaker, for example.

Network controller 124 is responsible for communication with other devices via a network not shown.

Second device 200 includes a wireless communication controller 202, a control unit 210, an operation unit 220, and a notification unit 222.

Although FIG. 1 shows an example configuration of second device 200 comprising one wireless communication controller, the wireless communication controller included in second device 200 may be plural.

Control unit 210 includes, for example, a processor 212, a memory 214, and a storage 216. Processor 212, memory 214, and storage 216 are respectively similar to processor 112, memory 114, and storage 116 described above.

Storage 216 may store pairing information 218. Pairing information 218 includes, for example, an address of one or a plurality of first devices 100 paired with second device 200 and a common key corresponding to each address.

Operation unit 220 accepts a user operation for second device 200. Operation unit 220 may be, for example, a cross key, a button, a lever, a stick and the like. Information indicating a user operation accepted by operation unit 220 may be transmitted to first device 100 via wireless communication.

Notification unit 222 includes one or a plurality of devices for notifying a user. Notification unit 222 may be, for example, a visible device such as an LED (Light Emitting Diode), or an audible device such as a speaker or a buzzer and the like. In addition, notification unit 222 may be a device that gives tactile information to a user, such as a vibrator or an electrothermal element and the like.

The first wireless communication controller 102 or the second wireless communication controller 104 of first device 100 is capable of wireless communication with the wireless communication controller 202 of second device 200. The wireless communication may follow Bluetooth, for example. At this time, first device 100 may operate as a central terminal, and second device 200 may operate as a peripheral terminal.

Communication system 1 may be applied to a system other than a game system, and devices that become a central terminal and a peripheral terminal are not limited. At least one of the central terminal or the peripheral terminal may be, for example, a general-purpose personal computer, a smartphone, a speaker, a printer, an input device, a camera and the like.

First device 100 and second device 200 may be capable of various wireless communications such as ZigBee®, wireless LAN (IEEE802.11), infrared communication and the like.

### B. Advertising Packet

Next, description is provided concerning an Advertising Packet that can be broadcast when first device 100 and second device 200 support Bluetooth Low Energy (BLE).

At least one of first device 100 or second device 200 can broadcast an advertising packet. A device in a state of broadcasting an advertising packet is also referred to as an "Advertiser". On the other hand, a device in a state of waiting for reception of an advertising packet to be broadcast is also referred to as a "Scanner".

The format of the advertising packet conforms to the specifications defined in Bluetooth. The advertising packet can include arbitrary data. The advertising packet is for unilateral data transmission from the Advertiser to the Scanner.

Types such as "Scannable", "Connectable", "Directed" and the like, are settable in the advertising packet. In the Advertiser, presence or absence of setting of these types may be determined.

The Scannable type indicates that the Scanner can transmit a Scan Request for requesting additional data to the advertising packet. The Scan Request is for requesting additional data. The Advertiser can transmit a Scan Response comprising the requested data to the Scanner in response to the Scan Request.

The wireless communication controller of the Advertiser can also notify a Bluetooth host (for example, a processor) of reception of the Scan Request when the wireless communication controller receives the Scan Request.

The Connectable type indicates that the Scanner can transmit a Connection Request to the advertising packet. In the Connection Request, a device capable of accepting the Connection Request is specifiable.

The Directed type indicates that the advertising packet is directed to a specified device.

In the Scanner, a passive scan or an active scan is settable. When the Scanner receives an advertising packet having the Scannable type set, the Scanner does not transmit a Scan Request if the Scanner is set to passive scan, and the Scanner transmits a Scan Request if the Scanner is set to active scan.

When the Scanner includes a plurality of wireless communication controllers, a specific wireless communication controller for transmitting the Scan Request in response to the advertising packet may be set in advance among the plurality of wireless communication controllers."

In the Scan Request, a device that should respond to the Scan Request is specifiable.

### C. Processing using Advertising Packet

Next, an example of processing according to the present embodiment using an advertising packet is described. As an example of processing using an advertising packet, description is provided concerning processing in which, when first device 100 is in a sleep state, and the user operates second device 200 to return first device 100 from the sleep state, second device 200 notifies the user of the return from the sleep state.

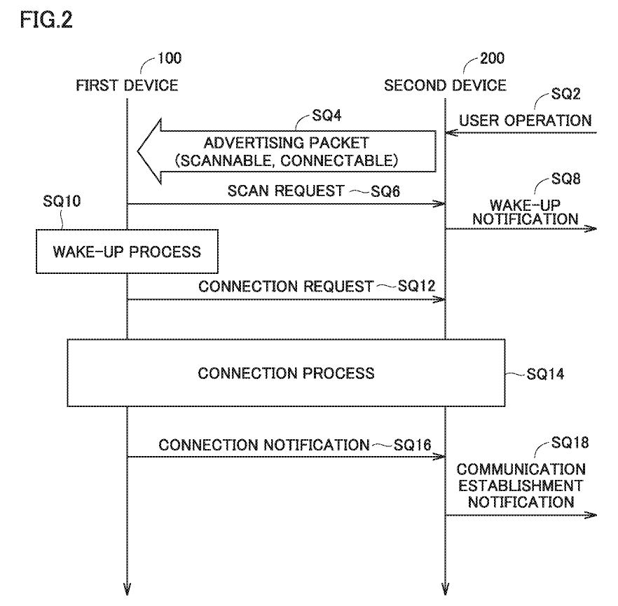

FIG. 2 is a sequence chart showing a processing procedure executed by communication system 1 according to the present embodiment. Before the start of the processing shown in FIG. 2, first device 100 and second device 200 may be paired. Further, it is assumed that first device 100 is in a sleep state before the start of the processing shown in FIG. 2. In the sleep state of first device 100, at least one of the first wireless communication controller 102 or the second wireless communication controller 104 is in a state of waiting for reception of an advertising packet.

Referring to FIG. 2, when a user operates operation unit 220 of second device 200 (sequence SQ2), the wireless communication controller 202 of second device 200 broadcasts an advertising packet (sequence SQ4). In sequence SQ2 and SQ4 shown in FIG. 2, second device 200 is an Advertiser, and first device 100 is a Scanner. First device 100, which is a Scanner, is set to active scan.

The Scannable type is set in the advertising packet broadcast in sequence SQ4. That is, second device 200 transmits the advertising packet having the Scannable type set. Therefore, when the wireless communication controller of first device 100 receives the advertising packet, the wireless communication controller transmits a Scan Request to second device 200 (sequence SQ6). First device 100 may determine a transmission destination of the Scan Request based on a source address of the received advertising packet.

When the wireless communication controller 202 of second device 200 receives the Scan Request, second device 200 executes a wake-up notification process (sequence SQ8). That is, second device 200 executes a notification process for notifying a user in response to the Scan Request from the other device that received the advertising packet.

The wake-up notification process is for notifying, for example, that processing for returning first device 100 from the sleep state has been started. The notification operation of the wake-up notification process may include at least one of lighting of a visible device such as an LED, output of sound from an audible device such as a speaker or a buzzer, or driving of tactile information such as a vibrator or an electrothermal element and the like.

In addition, first device 100 executes a wake-up process (sequence SQ10). The wake-up process may include at least one of processing for returning control unit 110 of first device 100 from the sleep state or processing for returning the wireless communication controller in the sleep state.

The Connectable type is set in the advertising packet broadcast in sequence SQ4. Therefore, after execution of the wake-up process, the wireless communication controller of first device 100 transmits a Connection Request to second device 200 (sequence SQ12). Along with setting the Connectable type, a device capable of accepting the Connection Request (for example, first device 100) may be specified, or may not be specified.

The wireless communication controller of first device 100 and the wireless communication controller 202 of second device 200 execute a connection process (sequence SQ14). That is, second device 200 executes the connection process with the other device to establish communication in response to the Connection Request from the other device.

The connection process may include processes such as, for example, Feature Exchange, update of a physical layer communication parameter, update of a maximum payload size of a data channel packet, exchange of a maximum transmission unit (MTU) of ATT (Attribute Protocol), and discovery of a service available in first device 100.

When the connection process is completed, the wireless communication controller of first device 100 transmits a Connection Notification to second device 200 (sequence SQ16).

When the wireless communication controller 202 of second device 200 receives the Connection Notification, second device 200 executes a communication establishment notification process (sequence SQ18). That is, second device 200 executes a notification process for notifying a user in response to the Connection Notification from the other device after communication establishment.

The communication establishment notification process is for notifying, for example, that communication between first device 100 and second device 200 is established, and first device 100 can be operated by second device 200. The notification operation of the communication establishment notification process may include at least one of driving of a vibrator of second device 200, or lighting of an LED according to a pattern indicating a player number assigned to second device 200.

As described above, since the purposes of notification are different for the wake-up notification process and the communication establishment notification process, the communication establishment notification process may be executed regardless of presence or absence of execution of the wake-up notification process.

At least a part of the notification operation of the wake-up notification process and at least a part of the notification operation of the communication establishment notification process may be the same. For example, both the wake-up notification process and the communication establishment notification process may include driving of a vibrator as a notification operation.

On the other hand, since there is a possibility that a user feels annoying or user confusion occurs due to notification being performed multiple times to the user, execution of the communication establishment notification process may be omitted when the wake-up notification process is executed.

An advertising packet with the Connectable type not set may be broadcast. Even in this case, since the Scanner can transmit a Scan Request, the Advertiser can notify the user that the assumed communication partner device is found without requiring communication establishment between devices.

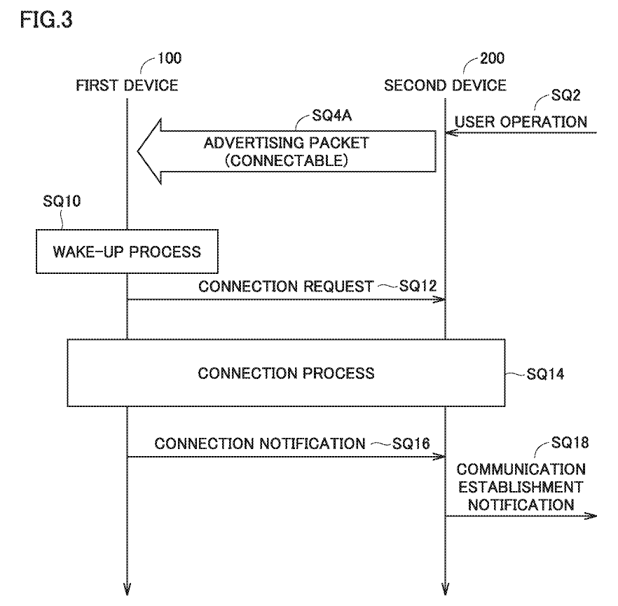

FIG. 3 is a sequence chart showing another processing procedure executed by communication system 1 according to the present embodiment. The Scannable type is not set in the advertising packet broadcast in sequence SQ4A of FIG. 3. Therefore, even if the wireless communication controller of first device 100 receives the advertising packet, the wireless communication controller does not transmit a Scan Request. Therefore, second device 200 executes the communication establishment notification process based on the Connection Notification received after the connection process is completed.

Second device 200 may be capable of selectively broadcasting the advertising packet having the Scannable type set (refer to FIG. 2) and the advertising packet having the Scannable type not set (refer to FIG. 3). In any case, the Connectable type may be set in the advertising packet. Only the Connectable type may be set, or in addition to setting the Connectable type, a device capable of accepting the Connection Request (for example, first device 100) may be specified.

When second device 200 broadcasts the advertising packet having the Scannable type set (refer to FIG. 2), second device 200 may execute a part of the communication establishment notification process executed after communication establishment through the advertising packet having the Scannable type not set (refer to FIG. 3) as the wake-up notification process executed in response to the Scan Request. In this case, a part or the entirety of the communication establishment notification process executed after communication establishment through the advertising packet having the Scannable type set may be omitted.

Furthermore, when second device 200 broadcasts the advertising packet having the Scannable type not set, second device 200 cannot execute the wake-up notification process, but second device 200 may execute at least a part of the notification operation of the wake-up notification process as the communication establishment notification process.

In this way, by adjusting the notification operations of the wake-up notification process and the communication establishment notification process, substantial difference in notification to a user can be prevented from occurring, except for notification timing, regardless of whether the advertising packet having the Scannable type set (refer to FIG. 2) or the advertising packet having the Scannable type not set (refer to FIG. 3) is broadcast.

### D. Example of Application to Plurality of Wireless Communication Controllers

As described above, first device 100 includes a plurality of wireless communication controllers (first wireless communication controller 102 and second wireless communication controller 104). The processing shown in FIG. 2 may be adapted to first device 100 comprising a plurality of wireless communication controllers, as described below.

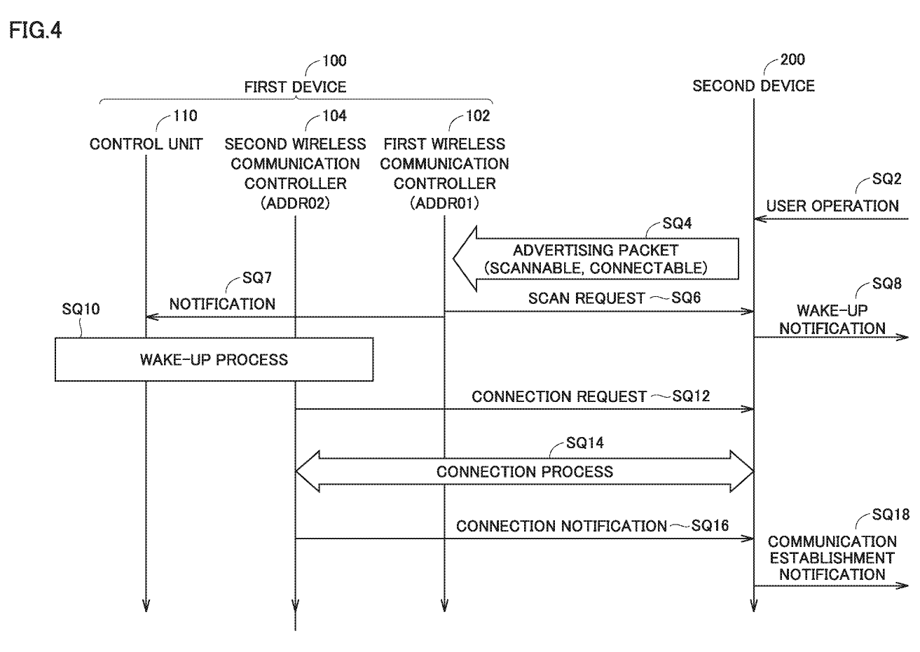

FIG. 4 is a sequence chart showing still another processing procedure executed by communication system 1 according to the present embodiment. It is assumed that control unit 110 and second wireless communication controller 104 of first device 100 are in a sleep state, and first wireless communication controller 102 is in a state of waiting for reception of an advertising packet, before the start of the processing shown in FIG. 4. Furthermore, first wireless communication controller 102 is set to active scan.

Further, it is assumed that the address of first wireless communication controller 102 is "ADDR01" and the address of second wireless communication controller 104 is "ADDR02". These addresses may conform to Bluetooth Device Address.

Referring to FIG. 4, when a user operates operation unit 220 of second device 200 (sequence SQ2), the wireless communication controller 202 of second device 200 broadcasts an advertising packet (sequence SQ4).

The Scannable type and the Connectable type are set in the advertising packet broadcast in sequence SQ4.

In the Connectable type, "ADDR02" (second wireless communication controller 104) may be specified as a device capable of accepting a Connection Request as an example. That is, in the Connectable type set in the advertising packet, the address of second wireless communication controller 104, which is different from first wireless communication controller 102 of first device 100 that transmits the Scan Request, may be specified as a device capable of accepting the Connection Request.

At the time when the advertising packet is broadcast in sequence SQ4, second wireless communication controller 104 is in the sleep state, so first wireless communication controller 102 of first device 100 receives the advertising packet. Then, first wireless communication controller 102 of first device 100 transmits a Scan Request for the advertising packet to second device 200 (sequence SQ6). When wireless communication controller 202 of second device 200 receives the Scan Request, second device 200 executes the wake-up notification process (sequence SQ8).

In addition, when first wireless communication controller 102 of first device 100 receives the advertising packet, first wireless communication controller 102 notifies control unit 110, which is an example of a Bluetooth host (sequence SQ7). The notification to control unit 110 may be an interrupt notification.

Control unit 110 executes the wake-up process in response to the notification from first wireless communication controller 102 (sequence SQ10). At this time, control unit 110 may return second wireless communication controller 104 from the sleep state.

Since the Connectable type is set, second wireless communication controller 104 of first device 100 transmits a Connection Request to second device 200 according to an instruction from control unit 110 (sequence SQ12). In this example, it is set in advance that second wireless communication controller 104 transmits the Connection Request when second wireless communication controller 104 receives the advertising packet having the Connectable type set. In the Connectable type, if an address of second device 200 capable of accepting a Connection Request is specified, the wireless communication controller of first device 100 corresponding to the specified address may transmit the Connection Request to second device 200.

When wireless communication controller 202 of second device 200 receives the Connection Request having address ADDR02 as a transmission source, wireless communication controller 202 validly processes the Connection Request without discarding the Connection Request. Then, second wireless communication controller 104 of first device 100 and wireless communication controller 202 of second device 200 execute the connection process (sequence SQ14). When the connection process is completed, second wireless communication controller 104 of first device 100 transmits a Connection Notification to second device 200 (sequence SQ16).

When wireless communication controller 202 of second device 200 receives the Connection Notification, second device 200 executes the communication establishment notification process (sequence SQ18).

In this way, when first device 100 includes a plurality of wireless communication controllers, wireless connection can be established using the wireless communication controller in the sleep state, even if one wireless communication controller is in the sleep state.

### E. Discard of Scan Request

As described above, when the Scanner set to active scan receives the advertising packet having the Scannable type set, the Scanner transmits a Scan Request to a transmission source of the advertising packet. Therefore, if first device 100 not paired with second device 200 is present in the proximity of second device 200, wireless communication controller 202 of second device 200 receives a Scan Request also from the unpaired first device 100. In this case, second device 200 may discard the Scan Request also from the unpaired first device 100.

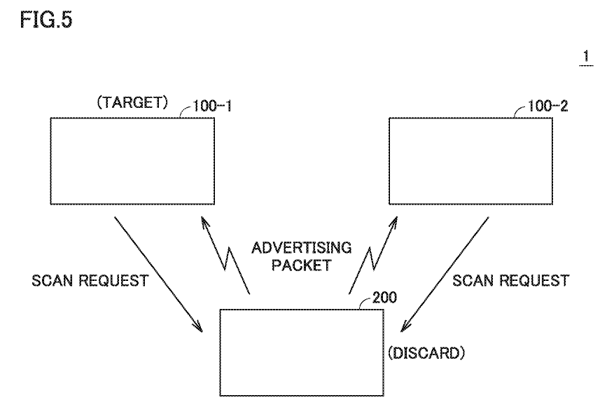

FIG. 5 is a diagram for explaining processing of discarding a Scan Request in communication system 1 according to the present embodiment. Referring to FIG. 5, it is assumed, for example, that first device 100-1, which is a target to be returned from the sleep state, and first device 100-2, which is not a target to be returned from the sleep state, are present within a reach range of the advertising packet broadcast by second device 200.

First device 100-1 and first device 100-2 transmit Scan Requests, respectively. Second device 200 validly processes the Scan Request from first device 100-1, which is the target, based on the source address of the Scan Request, while discarding the Scan Request from first device 100-2, which is not the target.

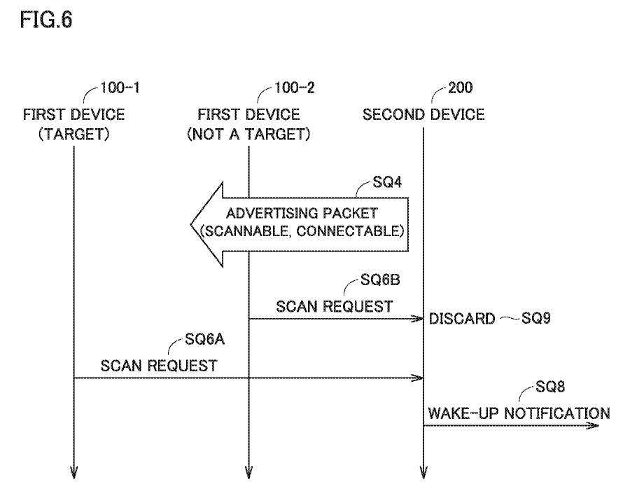

FIG. 6 is a sequence diagram showing a processing example shown in FIG. 5. Referring to FIG. 6, wireless communication controller 202 of second device 200 broadcasts an advertising packet (sequence SQ4).

When the wireless communication controller of first device 100-2 receives the advertising packet, the wireless communication controller transmits a Scan Request to second device 200 (sequence SQ6B). Second device 200 discards the Scan Request from first device 100-2, which is not the target (sequence SQ9). Alternatively, second device 200 may not execute necessary specified processing after receiving the Scan Request.

Similarly, when the wireless communication controller of first device 100-1 receives the advertising packet, the wireless communication controller transmits a Scan Request to second device 200 (sequence SQ6A). When second device 200 receives the Scan Request from first device 100-1, which is the target, second device 200 executes the wake-up notification process (sequence SQ8).

Processing for discarding such a Scan Request may be implemented using filtering based on one or a plurality of addresses registered in pairing information 218. For example, second device 200 may discard the Scan Request if the source address of the received Scan Request does not match any address registered in pairing information 218. Alternatively, filtering may be performed based on an address of one or a plurality of wireless communication controllers included in first device 100 that established communication immediately before sleep.

### F. Other Application Examples

As an example of processing using an advertising packet, processing for notifying a user of a return from the sleep state from second device 200 when returning first device 100 from the sleep state was described, but the processing is not limited to this and is applicable to arbitrary processing.

For example, application such as searching for one device out of a pair of devices paired in advance is also possible. If one device broadcasts an advertising packet, and the other device is present within the reach range of the advertising packet, a Scan Request is responded. Therefore, based on whether one device can receive the Scan Request from the other device, it can be determined whether the other device that is the search target is present around the one device.

A rough position where the device that is the search target is present can be determined by sequentially changing a position of one device.

### G. Modification Examples

Necessary processing in the above communication device may be realized by a processor executing a program, or a part or all of the processing may be realized by a hardwired circuit such as an ASIC (Application Specific Integrated Circuit) or an FPGA (Field Programmable Gate Array) and the like. For example, the wireless communication controller may be responsible for at least a part of the necessary processing in the above communication device.

In the present specification, the term "processor" encompasses hardwired circuits such as an ASIC or an FPGA and the like, in addition to a CPU or a GPU and the like. The hardwired circuit may be an IC (Integrated Circuit) having a small circuit scale.

The configuration of first device 100 or second device 200 is an example, and the configuration may not include a part of the configuration, or may include another configuration. For example, first device 100 may not include display 120.

In the above description, for convenience of description, the wireless communication controller is described as a configuration independent of the control unit, but the control unit may include at least a part of the wireless communication controller. The plurality of wireless communication controllers may be mounted on a single substrate. The hardware of first device 100 and second device 200 may be any implementation.

### H. Example of Effect

For example, the Scannable type is set in the advertising packet broadcast by wireless communication controller 202 of second device 200 in sequence SQ4 shown in FIG. 2. Therefore, when wireless communication controller 202 of second device 200 broadcasts the advertising packet, second device 200 can receive a Scan Request before the connection process (sequence SQ14) is completed (sequence SQ6). Second device 200 can execute the wake-up notification process (sequence SQ8) before the communication establishment notification process executed after completion of the connection process. In this way, time from when the user operates operation unit 220 of second device 200 until notifying the user can be shortened.

The device used for notification of the wake-up notification process or the communication establishment notification process, a method of notification, timing of notification and the like, may be any. Only at least one of the wake-up notification process or the communication establishment notification process may be executed. The content of notification is not limited based on the names "wake-up notification" and "communication establishment notification".

In the communication system according to the present embodiment, notification is performed in response to a Scan Request of a communication partner. Therefore, the user can be notified that the assumed communication partner device has been found without requiring communication establishment between devices. As described above, the user can be notified that the communication partner device has returned from sleep, or that control and the like, has become possible due to communication establishment. In addition, since the Connectable type is set in the advertising packet, the wake-up process or the connection process is executed following the Scan Request, so the processing time can be shortened overall.

Bluetooth was illustrated as a standard of wireless communication in the above disclosure, but other standards may be used.

The embodiment disclosed this time should be considered illustrative in all respects and not restrictive.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A device, comprising:
a wireless communication controller; and
a notification unit,
wherein the device is configured to:
transmit a scannable advertising packet, and
execute a first notification process for performing first notification to a user in response to a scan request from another device that received the advertising packet.

2. The device according to claim 1,
wherein the advertising packet is connectable.

3. The device according to claim 2,
wherein the device is configured to execute a connection process with the another device to establish communication in response to a connection request from the another device, and
execute a second notification process for performing second notification to the user in response to a connection notification from the another device after communication is established.

4. The device according to claim 3,
wherein the device is configured to execute the second notification process regardless of presence or absence of execution of the first notification process.

5. The device according to claim 3,
wherein the device is configured to omit execution of the second notification process when the first notification process is executed.

6. The device according to claim 3,
wherein at least a part of a notification operation of the first notification process and at least a part of a notification operation of the second notification process are the same.

7. The device according to claim 2,
wherein the scan request is transmitted by a first wireless communication controller of the another device, and wherein, in the connectable advertising packet, an address of a second wireless communication controller of the another device, which is different from the first wireless communication controller, is specified as a device capable of accepting a connection request.

8. One or more non-transitory computer-readable storage media storing instructions that cause one or more processors to perform operations comprising:
transmitting a scannable advertising packet; and
executing a first notification process for performing first notification to a user in response to a scan request from another device that received the advertising packet.

9. The one or more non-transitory computer-readable storage media according to claim 8, wherein the advertising packet is connectable.

10. The one or more non-transitory computer-readable storage media according to claim 9, wherein the operations further comprise:
executing a connection process with the another device to establish communication in response to a connection request from the another device; and
executing a second notification process for performing second notification to the user in response to a connection notification from the another device after communication is established.

11. The one or more non-transitory computer-readable storage media according to claim 10, wherein the operations further comprise:
executing the second notification process regardless of presence or absence of execution of the first notification process.

12. The one or more non-transitory computer-readable storage media according to claim 10, wherein the operations further comprise:
omitting execution of the second notification process when the first notification process is executed.

13. The one or more non-transitory computer-readable storage media according to claim 9,
wherein the scan request is transmitted by a first wireless communication controller of the another device, and wherein, in the connectable advertising packet, an address of a second wireless communication controller of the another device, which is different from the first wireless communication controller, is specified as a device capable of accepting a connection request.

14. A computer-implemented method, comprising:
transmitting a scannable advertising packet; and
executing a first notification process for performing first notification to a user in response to a scan request from another device that received the advertising packet.

15. The computer-implemented method according to claim 14, wherein the advertising packet is connectable.

16. The computer-implemented method according to claim 15, further comprising:
executing a connection process with the another device to establish communication in response to a connection request from the another device; and
executing a second notification process for performing second notification to the user in response to a connection notification from the another device after communication is established.

17. The computer-implemented method according to claim 16, further comprising:
executing the second notification process regardless of presence or absence of execution of the first notification process.

18. The computer-implemented method according to claim 16, further comprising:
omitting execution of the second notification process when the first notification process is executed.

19. The computer-implemented method according to claim 15,
wherein the scan request is transmitted by a first wireless communication controller of the another device, and wherein, in the connectable advertising packet, an address of a second wireless communication controller of the another device, which is different from the first wireless communication controller, is specified as a device capable of accepting a connection request.

20. A communication system, comprising:
a first device comprising a wireless communication controller; and
a second device comprising a wireless communication controller and a notification unit, wherein the second device is configured to transmit a scannable advertising packet,
wherein the first device is configured to transmit a scan request to the second device when the first device receives the advertising packet from the second device, and
wherein the second device is configured to execute a first notification process for performing first notification to a user in response to the scan request from the first device.
